(19) United States
(12) Patent Application Publication
(10) Pub. No.: US 2010/0232159 A1
(43) Pub. Date: Sep. 16, 2010

(54) ILLUMINATION DEVICE WITH SELECTABLE LIGHT DISTRIBUTION CURVES

(75) Inventor: CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/632,923

(22) Filed: Dec. 8, 2009

(30) Foreign Application Priority Data
Mar. 11, 2009 (CN) 200910300790.4

(51) Int. Cl. F21V 3/00

(52) U.S. Cl. 362/277

(57) ABSTRACT

An illumination device includes a light source and a light transmissive element having a plurality of transmissive units. The light transmissive element is movable such that any of the plurality of transmissive units can be selectively positioned below the light source, and said any of plurality of transmissive units can thereby receive light emitted from the light source and convert the light distribution curve of the light into a different light distribution curve.

### BACKGROUND

1. Technical Field

The present disclosure generally relates to illumination devices, and particularly to an illumination device configured (i.e., structured and arranged) to be able to output light having a selectable light distribution curve.

2. Description of Related Art

LEDs have recently been used extensively as light sources for illumination devices due to their high luminous efficiency, low power consumption and long working life. The light emitted from light sources can form a constant light distribution in the space around the light sources and the light distribution of the light sources defined by coordinates can be represented by a so-called light distribution curve. Referring to FIG. 9, a typical light distribution curve of an LED, so-called Lambertian distribution, is shown. As shown in FIG. 9, a full width at half maximum (FWHM) of the light distribution curve of the typical LED is within ±60°; in other words, the FWHM of the typical LED is equal to 120°.

However, although an optical unit such as a lamp shade can be used to change the light distribution curve of light sources, once a light source and the optical unit are provided together to emit light with a predetermined light distribution curve, it is almost impossible to change the predetermined light distribution curve or make the same light source emit light with another light distribution curve without changing the light source or the optical unit.

Therefore, what is needed is an illumination device that overcomes the described limitations.

### BRIEF DESCRIPTION OF THE DRAWINGS

Many aspects of the disclosed illumination device can be better understood with reference to the following drawings. The components in the drawings are not necessarily drawn to scale, the emphasis instead being placed upon clearly illustrating the principles of the present illumination device.

FIG. 1 is a schematic view of an illumination device of a first embodiment.

FIG. 2 is a schematic view of an illumination device of a second embodiment, the illumination device including four transmissive units with microstructures formed thereon.

FIGS. 3a-3d are enlarged cross-sectional views of the four transmissive units of the illumination device of FIG. 2, respectively.

FIGS. 4a-4d are light distribution curves respectively generated by light through the four transmissive units of FIG. 3a-FIG. 3d.

FIGS. 5a-5b are schematic views showing two variations of the transmissive units of the illumination device of the second embodiment.

FIG. 6 is a schematic view of an illumination device of a third embodiment.

FIG. 7 is a schematic view of a variation of the third embodiment of the illumination device.

FIG. 8 is a schematic view of an illumination device of a fourth embodiment.

FIG. 9 is a typical light distribution curve of an LED.

### DETAILED DESCRIPTION

Reference will now be made to the drawings to describe the illumination device in accordance with various embodiments of the present disclosure, in detail.

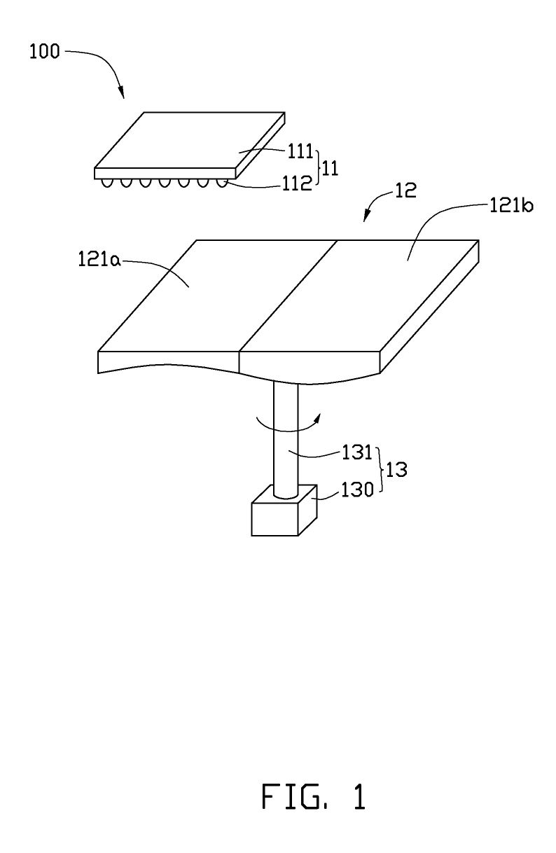

Referring to FIG. 1, an illumination device 100 of a first embodiment includes a light source 11, a light transmissive element 12, and a driving module 13.

The light source 11 includes a substrate 111, and a plurality of illumination units 112 arranged on the substrate 111. In one embodiment, the illumination units 112 are light emitting diodes (LEDs). In an alternative embodiment, the illumination units 112 can be, for example, fluorescent lamps, cold cathode fluorescent lamps (CCLFs), energy saving lights, gas-discharge lamps, metal halide lamps, or incandescent light bulbs.

The light transmissive element 12 is structured and arranged at a light emitting side of the light source 11. The light transmissive element 12 is plane-shaped and includes a first transmissive unit 121a adjacent a second transmissive unit 121b. The first transmissive unit 121a is a planoconcave lens and can diffuse light emitted from the light source 11. The second transmissive unit 121b is a planoconvex lens and can focus light emitted from the light source 11 onto a predetermined area.

The light transmissive element 12 can be made of materials such as silicone, glass, polymethyl methacrylate (PMMA), polycarbonate (PC), epoxy, or polyethylene terephthalate (PET). In one embodiment, the light transmissive element 12 includes a plurality of transmissive units selected from a group of lenses consisting of convex lens, concave lens, spherical lens, and fresnel lens.

The driving module 13 includes a rotatable shaft 131 and a motor 130 driving the rotatable shaft 131 to rotate. The rotatable shaft 131 has one end portion fixed to the center of the light transmissive element 12, for rotating the element 12.

The driving module 13 can drive the rotatable shaft 131 to rotate, thereby to make the light transmissive element 12 rotate; thus, the first transmissive unit 121a or the second transmissive unit 121b of the light transmissive element 12 is selectively positioned under the light source 11. When the first transmissive unit 121a is selected to be positioned under the light source 11, the light emitted from the light source 11 with a primary light distribution curve can be substantially directed through the first transmissive unit 121a. As a result, the first transmissive unit 121a of the light transmissive element 12 converts the primary light distribution curve of the light emitted from the light source 11 into a first light distribution curve. When the second transmissive unit 121b is selected to be positioned under the light source 11, the light emitted from the light source 11 with the primary light distribution curve can be substantially directed through second transmissive unit 121b. As a result, the second transmissive unit 121b of the light transmissive element 12 converts the primary light distribution curve of the light from the light source 11 into a second light distribution curve.

Because different light distribution curves can be selected with the illumination device 100 by only rotating the light transmissive element 12 to let the light source 11 be selectively positioned over the different transmissive units 121a, 121b of the light transmissive element 12, the light emitted from the light source 11 can be selectively directed through different parts of the light transmissive element 12 to illuminate different predetermined areas according to the different light distribution curves. Thus, light waste is reduced and power consumption of the illumination device 100 can be reduced.

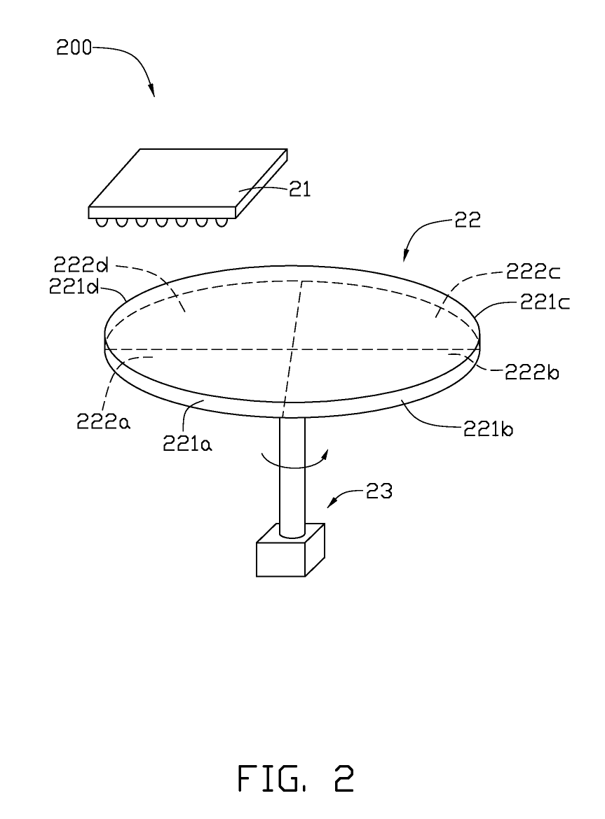

Referring to FIG. 2, an illumination device 200 of a second embodiment is shown. The illumination device 200 is similar to the first illumination 100 except that a transmissive element 22 of the illumination device 200 includes a first transmissive unit 221a, a second transmissive unit 221b, a third transmissive unit 221c, and a fourth transmissive unit 221d. Each transmissive unit 221a, 221b, 221c, 221d includes a light incident surface adjacent to a light source 21 and a light emitting surface opposite to the light incident surface. The light emitting surface of the first transmissive unit 221a includes a first microstructure 222a formed thereon. The light emitting surface of the second transmissive unit 221b includes a second microstructure 222b formed thereon. The light emitting surface of the third transmissive unit 221c includes a third microstructure 222c formed thereon. The light emitting surface of the fourth transmissive unit 221d includes a fourth microstructure 222d formed thereon.

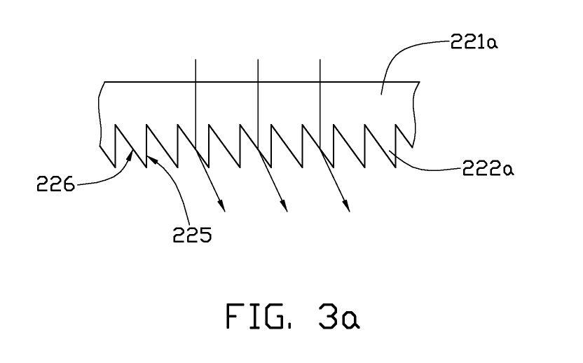

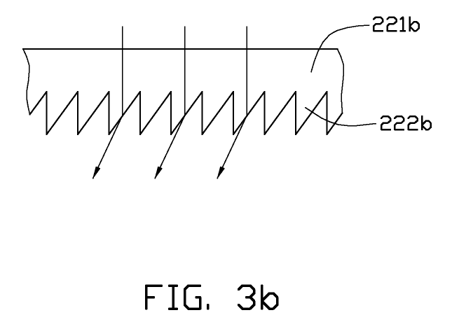

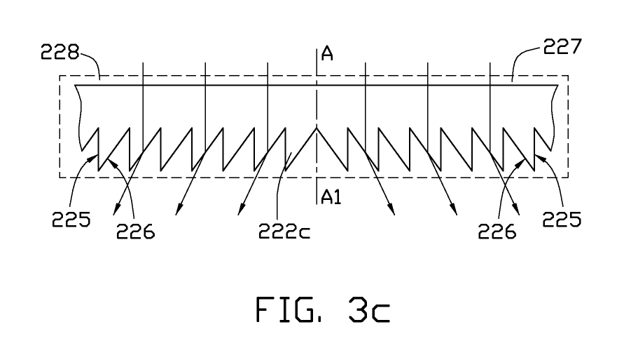

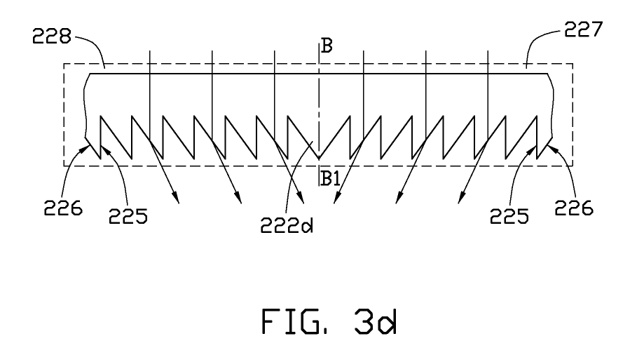

Referring to FIG. 3a, an enlarged cross-sectional view of the first transmissive unit 221a with the first microstructure 222a is shown. The first microstructure 222a includes a plurality of first serrations. Each first serration includes a first surface 225 perpendicular to the light emitting surface of the first transmissive units 221a, and a second surface 226 connected to the first surface 225 at an acute angle. Most of the light emitted from the light source 21 is substantially refracted at the second surface 226 and emitted therefrom.

In an alternative embodiment, the first surface 225 can instead be at an acute angle to the light emitting surface of the first transmissive unit 221a. In other alternative embodiments, the angle between the first surface 225 and the second surface 226 can also be adjusted to obtain different oblique transmission angles of the light emitted from the second surface 226. In further alternative embodiments, angles between the first surface 225 and the first transmissive unit 221a or between the second surface 226 and the first transmissive unit 221a can also be adjusted to obtain different transmission angles of the light emitted from the second surface 226.

Referring to FIG. 3b, an enlarged cross-sectional view of the second transmissive unit 221b with the second microstructure 222b is shown. The second microstructure 222b of the second transmissive unit 221a includes a plurality of second serrations arranged opposite to the first serrations. Thus, light emitted from the second transmissive unit 221b has an opposite direction to that of the light emitted from the first transmissive unit 221a.

Referring to FIG. 3c, an enlarged cross-sectional view of the third transmissive unit 221c with the third microstructure 222c is shown. The third microstructure 222c of the third transmissive unit 221c includes a first sub-structure 227 and a second sub-structure 228. The first sub-structure 227 has the same configuration as the first microstructure 222a of the first transmissive unit 221a. The second sub-structure 228 has the same configuration as the second microstructure 222b of the second transmissive unit 221b. Thus, the first sub-structure 227 and the second sub-structure 228 are symmetrical about an axis AA1. In detail, a second surface 226 of the first sub-structure 227 or a second surface 226 of the second sub-structure 228 extends away from the axis AA1 along a direction from the incident surface to the light emitting surface of the third transmissive unit 221c. On the other hand, except the central second surfaces 226 which are connected with each other by themselves, an extension of the second surface 226 of the first sub-structure 227 is connected with an extension of the corresponding second surface 226 of the second sub-structure 228 at a point above the light emitting surface of the third transmissive unit 221c. Thus, the third transmissive unit 221c diffuses the light emitted from the light source 21.

Referring to FIG. 3d, an enlarged cross-sectional view of the fourth transmissive unit 221d with the fourth microstructure 222d is shown. The fourth microstructure 222d of the fourth transmissive unit 221d includes a first sub-structure 227 and a second sub-structure 228. The first sub-structure 227 has the same configuration as the second microstructure 222b of the second transmissive unit 221b. The second sub-structure 228 has the same configuration as the first microstructure 222a of the first transmissive unit 221a. Thus, the first sub-structure 227 and the second sub-structure 228 are symmetrical on an axis BB1. In detail, a second surface 226 of the first sub-structure 227 or a second surface 226 of the second sub-structure 228 extends toward the axis BB1 along a direction from the incident surface to the light emitting surface of the fourth transmissive unit 221d. On the other hand, except the central second surfaces 226 which are connected with each other by themselves, an extension of the second surface 226 of the first sub-structure 227 is connected with an extension of the corresponding second surface 226 of the second sub-structure 228 at a point below the light emitting surface of the fourth transmissive unit 221d. Thus, the fourth transmissive unit 221d focuses the light emitted from the light source 21 along the axis BB1.

A driving module 23 can drive a rotatable shaft 231 to rotate to thereby make the light transmissive element 22 rotate with the rotatable shaft 231. Thus, the four transmissive units 221a, 221b, 221c, 221d of the light transmissive element 22 are selectively positioned under the light source 21. Therefore, the light emitted from the light source 21 with a primary light distribution curve will correspondingly pass through one of the four transmissive units 221a, 221b, 221c, 221d therebelow. As a result, the four transmissive units 221a, 221b, 221c, 221d of the light transmissive element 22 convert the primary light distribution curve of the light from the light source 21 into four different light distribution curves, respectively.

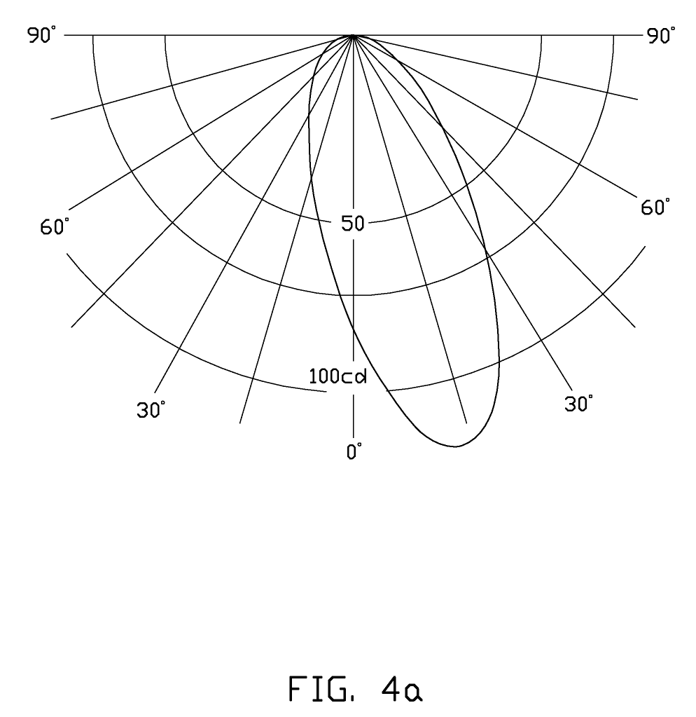

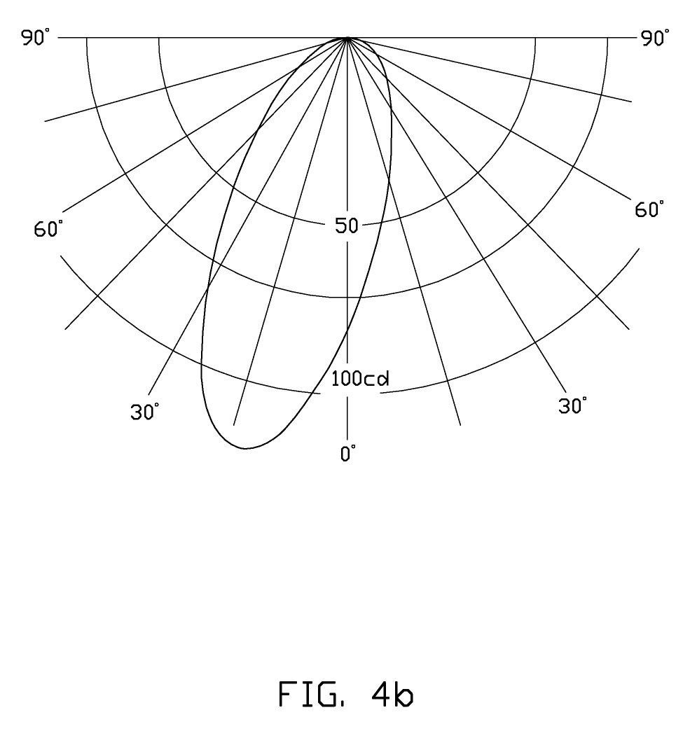

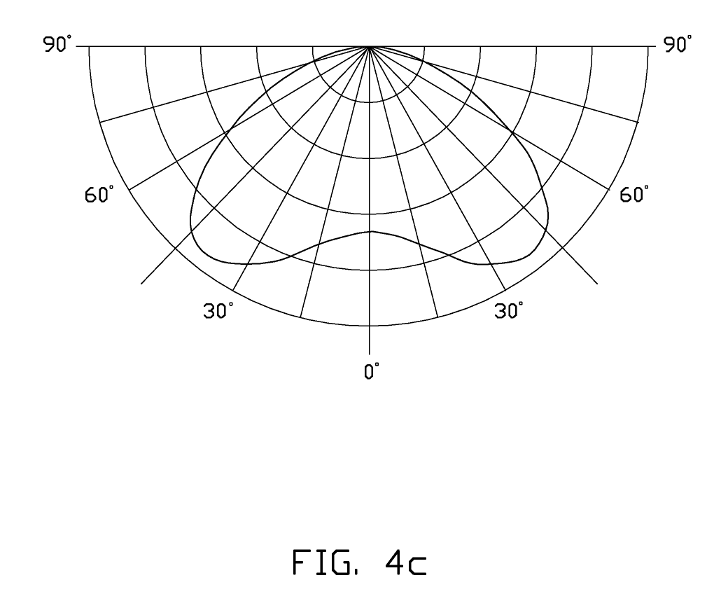

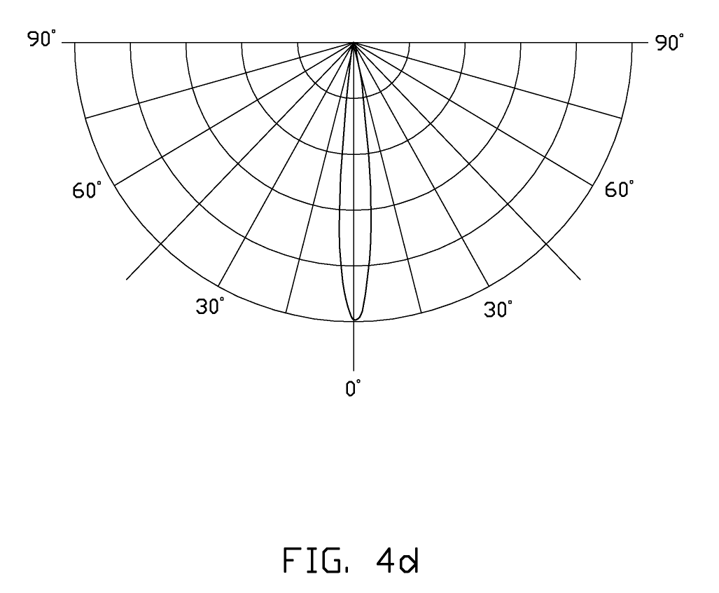

Referring to FIG. 4a-4d, four different light distribution curves generated by the four transmissive units 221a, 221b, 221c, 221d of the light transmissive element 22 are shown, respectively. FIG. 4a is a first light distribution curve generated by the first transmissive unit 221a of the light transmissive element 22. The light emitted from first transmissive unit 221a is deflected by the first microstructure 222a towards a first direction. The bigger the angle between the first surface 225 and the second surface 226 of the first transmissive unit 221a is, the deflected angle of the light emitted from the first transmissive unit 221a is bigger.

FIG. 4b is a second light distribution curve generated by the second transmissive unit 221b of the light transmissive element 22. The light emitted from second transmissive unit 221b is deflected by the second microstructure 222b towards a second direction opposite to the first direction.

FIG. 4c is a third light distribution curve generated by the third transmissive unit 221c of the light transmissive element 22. The light emitted from third transmissive unit 221c is diffused by the third microstructure 222c.

FIG. 4d is a fourth light distribution curve generated by the fourth transmissive unit 221d of the light transmissive element 22. The light emitted from fourth transmissive unit 221c is focused by the fourth microstructure 222d along the axis BB1 between the first sub-structure 227 and the second sub-structure 228.

In an alternative embodiment, the microstructure 222 formed on the light emitting surface of each transmissive unit 221 can be other configuration such as arc-shaped protrusions, columned stripe-shaped protrusions, concavities, or concave grooves.

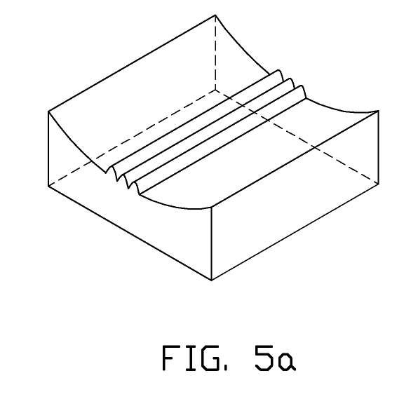

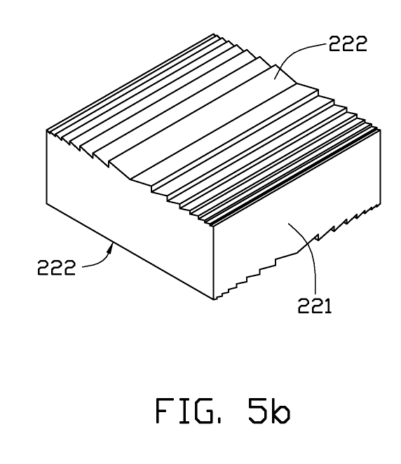

Referring to FIG. 5a, a transmissive unit 221 of one embodiment employing a planoconcave lens with arc-shaped stripe protrusions formed on a concave surface is shown. The planoconcave lens includes an extended trough and the stripe protrusions are formed on the bottom of the trough and parallel to each other.

In an alternative embodiment, the microstructures 222 can also be formed on both the light emitting surface and the light incident surface of each transmissive unit 221 of the light transmissive element 22.

In further alternative embodiments, the microstructures 222 respectively formed on the light emitting surface and the light incident surface of each transmissive unit 221 are different. Referring to FIG. 5b, an exemplary transmissive unit 221 having different microstructures respectively formed on the light emitting surface and the light incident surface is shown. The microstructures formed on one of the light emitting surface and the light incident surface of the transmissive unit 221 includes a plurality of first triangle-shaped stripe protrusions extending along a first direction. A cross-sectional view of the first triangle-shaped stripe protrusions is similar to FIG. 3c. The microstructures formed on the other one of the light emitting surface and the light incident surface of the transmissive unit 221 includes a plurality of second triangle-shaped stripe protrusions extending along a second direction perpendicular to the first direction. A cross-sectional view of the second triangle-shaped stripe protrusions is similar to FIG. 3d.

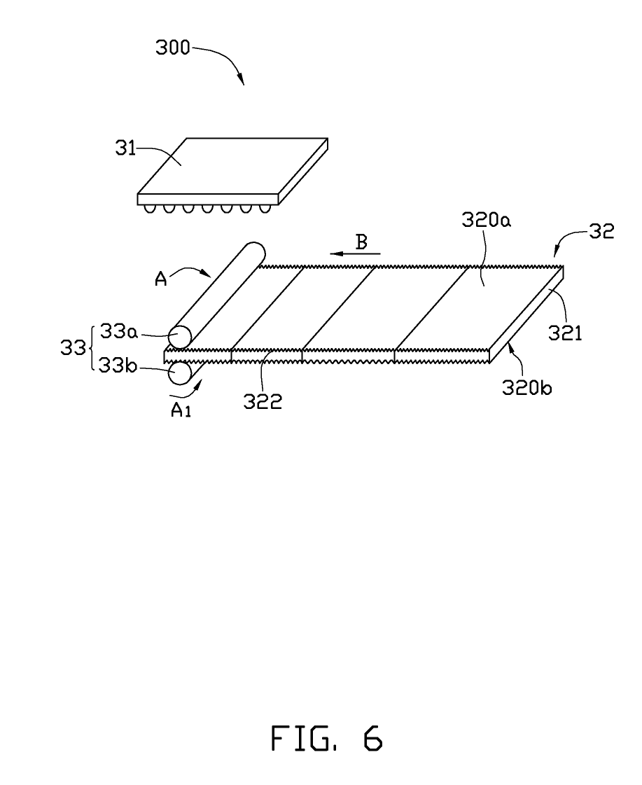

Referring to FIG. 6, an illumination device 300 of a third embodiment is shown. The illumination device 300 is similar to the second illumination 200.

The illumination device 300 includes a light source 31, a plane-shaped light transmissive element 32, and a driving module 33 employing a pair of rollers. The light transmissive element 32 includes a row of four plane-shaped transmissive units 321. Each transmissive unit 321 includes a light incident surface 320a and a light emitting surface 320b. The light incident surface 320a has a microstructure such as arc-shaped stripe protrusions formed thereon. The four light emitting surfaces 320b have four different microstructures such as serrated protrusions, concave grooves, arc-shaped stripe protrusions, and serrated stripe protrusions formed thereon, respectively.

The driving module 33 includes a first roller 33a and a second roller 33b arranged at two opposite sides of the transmissive element 32, respectively. In this embodiment, the first and second rollers 33a, 33b are made of rubber to avoid damaging the microstructures formed on the light incident surface 320a and the light emitting surface 320b when the first and second rollers 33a, 33b are rotated to move the transmissive element 32. In this embodiment, the first roller 33a is rotated along a first direction “A” and the second roller 33b is rotated along a second direction “A1” opposite to the first direction “A” so as to move the transmissive element 32 along a horizontal direction “B”. The movement of the transmissive element 32 along the horizontal direction “B” makes a selected one of the four transmissive units 321 of the light transmissive element 32 be located under the light source 31, such that the light emitted from the light source 31 with a primary light distribution curve can correspondingly be directed through the selected one of the four transmissive units 321. As a result, the four transmissive units 321 of the light transmissive element 32 convert the primary light distribution curve of the light from light source 31 into four different light distribution curves, respectively.

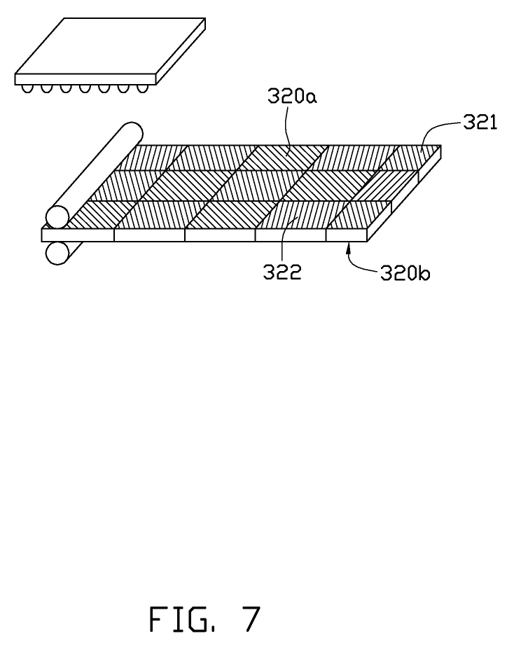

Referring to FIG. 7, in an alternative embodiment, the light transmissive element 32 includes a plurality of plane-shaped transmissive units 321 arranged in matrix. The light incident surfaces 320a of the plane-shaped transmissive units 321 have a plurality of microstructures formed thereon, respectively. The microstructures formed on the light incident surfaces 320a of the transmissive units 321 are different from each other. All the light emitting surfaces 320b of the plane-shaped transmissive units 321 are smooth surfaces.

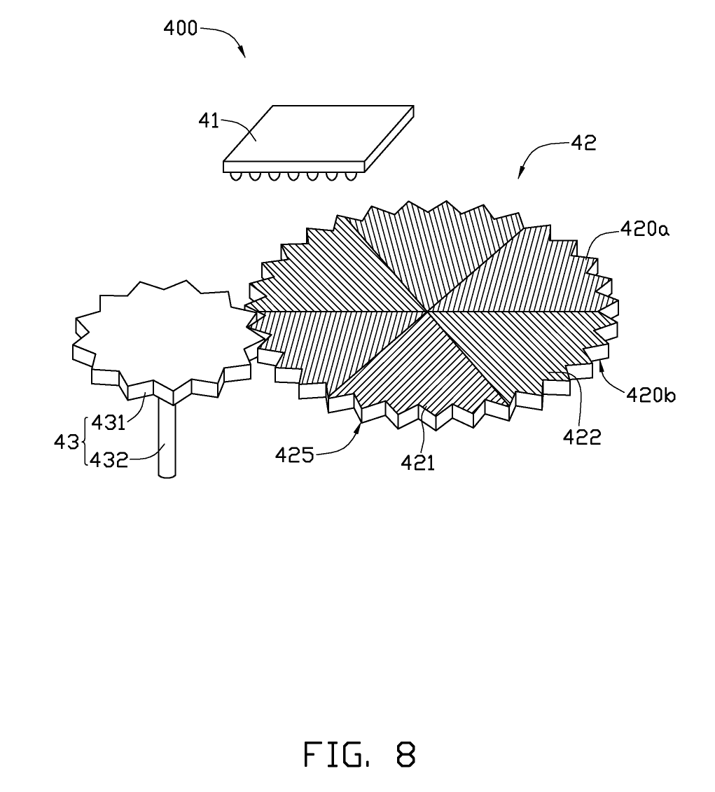

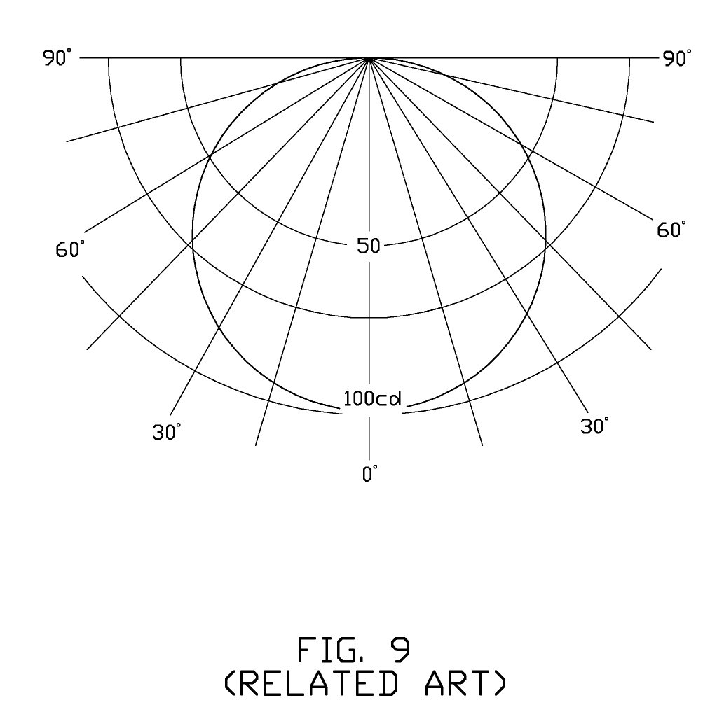

Referring to FIG. 8, an illumination device 400 of a fourth embodiment is shown. The illumination device 400 includes a light source 41, a disk-shaped light transmissive element 42 having a first toothed periphery 425 formed on an outer edge thereof, and a driving module 43.

The light transmissive element 42 includes a plurality of sector-shaped transmissive units 421 arranged around a center thereof. Each transmissive unit 421 includes a light incident surface 320a having a microstructure 422 formed thereon and a smooth light emitting surface 320b.

The driving module 43 includes a gear wheel having a second toothed periphery 431 corresponding to and engaging with the first toothed periphery 425. The driving module 43 further includes a rotatable shaft 432. The rotatable shaft 432 has one end portion fixed to the center of gear wheel for rotating the gear wheel. The driving module 43 can rotate the light transmissive element 42 around its center so as to make the light source 41 just face to a selected transmissive unit 421, such that the light emitted from the light source 42 with a primary light distribution curve can be correspondingly directed through the selected transmissive unit 421 therebelow. As a result, the transmissive units 421 of the light transmissive element 42 selectively convert the primary light distribution curve of the light from the light source 41 into different light distribution curves, respectively. In an alternative embodiment, the first gear ring 425 and the second gear ring 431 can be replaced by friction wheels made of rubber.

A method of converting light distribution curve is described as follows.

Firstly, a light source is provided. The light source can be, for example, fluorescent lamps, cold cathode fluorescent lamps, energy-saving lamps, gas discharge lamps, metal halide lamps, or incandescent light bulbs.

Secondly, a light transmissive element is provided. The light transmissive element includes a plurality of transmissive units each of which can convert a primary light distribution curve of the light from the light source into a corresponding different light distribution curve. The transmissive units can be selected from a group of lenses consisting of planoconvex lens, convex lens, planoconcave lens, concave lens, spherical lens, and fresnel lens. Each transmissive unit includes a light incident surface and a light emitting surface opposite to the light incident surface. A plurality of microstructures such as serrated protrusions, concave grooves, etc. can be formed on at least one of the light incident surface and the light emitting surface of each transmissive unit. In an alternative embodiment, two different microstructures are respectively formed on both the light incident surface and the light emitting surface of each transmissive unit.

Thirdly, the light transmissive element is moved to make the light source be selectively positioned corresponding to a selected one of the transmissive units of the light transmissive element, such that the light emitted from the light source with a primary light distribution curve correspondingly passes through the selected transmissive unit.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. An illumination device, comprising:
a light source; and
a light transmissive element comprising a plurality of transmissive units;
wherein the light transmissive element is movable such that any of the plurality of transmissive units can be selectively positioned corresponding to the light source, and said any of plurality of transmissive units can thereby receive light emitted from the light source and convert a light distribution curve of the light into a different light distribution curve.

2. The illumination device of claim 1, wherein the light transmissive element is made of a material selected from one of following materials: silicone, glass, polymethyl methacrylate, polycarbonate, epoxy, and polyethylene terephthalate.

3. The illumination device of claim 1, wherein the plurality of transmissive units are selected from a group of lenses consisting of planoconvex lens, convex lens, planoconcave lens, concave lens, spherical lens, and fresnel lens.

4. The illumination device of claim 1, wherein each of the plurality of transmissive units comprises a light incident surface and a light emitting surface opposite to the light incident surface, a microstructure is formed on at least one of the light incident surface and the light emitting surface of each of the plurality of transmissive units.

5. The illumination device of claim 4, wherein the at least one of the light incident surface and the light emitting surface comprises a concave surface, and the microstructure includes arc-shaped stripe protrusions formed along a trough of the concave surface.

6. The illumination device of claim 4, wherein the microstructure comprises one of a plurality of serrated protrusions, a plurality of concave grooves, a plurality of arc-shaped stripe protrusions, and a plurality of serrated stripe protrusions.

7. The illumination device of claim 4, wherein the microstructure comprises a plurality of serrated protrusions, each of the serrated protrusion comprises a first surface perpendicular to the light emitting surface, and a second surface connected to the first surface at an angle.

8. The illumination device of claim 7, wherein the angle between the first surface and the second surface is an acute angle.

9. The illumination device of claim 1, wherein each of the plurality of transmissive units comprises a light incident surface and a light emitting surface opposite to the light incident surface, one of the plurality of transmissive units comprises a first sub-structure and a second sub-structure formed on at least one of the light incident surface and the light emitting surface, the first sub-structure comprises a first surface perpendicular to the light emitting surface, and a second surface connected to the first surface at an acute angle, the first sub-structure and the second sub-structure are symmetrical about an axis.

10. The illumination device of claim 9, wherein the first sub-structure and the second sub-structure of one of the plurality of transmissive units diffuse the light emitted from the light source.

11. The illumination device of claim 9, wherein the first sub-structure and the second sub-structure of one of the plurality of transmissive units focus the light emitted from the light source along a symmetry axis.

12. The illumination device of claim 4, wherein the microstructure is formed on both the light incident surface and the light emitting surface of each of the plurality of transmissive units.

13. The illumination device of claim 12, wherein the microstructure formed on the light incident surface is different from that formed on the light emitting surface of each of the plurality of transmissive units.

14. The illumination device of claim 12, wherein the microstructure formed on the light incident surface includes a plurality of first triangle-shaped stripe protrusions extending along a first direction, the microstructure formed on the light emitting surface includes a plurality of second triangle-shaped stripe protrusions extending along a second direction perpendicular to the first direction.

15. The illumination device of claim 1 further comprising a driving module to move the light transmissive element.

16. The illumination device of claim 15, wherein the transmissive units of the light transmissive element are arranged in a row, and the driving module comprises a roller system configured for moving the light transmissive element along a horizontal direction.

17. The illumination device of claim 15, wherein the plurality of transmissive units of the light transmissive element are arranged around a center thereof, and the driving module comprises a gear-driving system configured for rotating the light transmissive element around the center.

18. The illumination device of claim 15, wherein the plurality of transmissive units of the light transmissive element are arranged around a center thereof which is fixed to a rotatable shaft, and the driving module comprises a rotatable system configured for rotating the rotatable shaft so that the transmissive element can rotate with the rotatable shaft.

19. A method of modulating characteristic of light comprising:
providing a light source for generating a light;
providing a light transmissive element comprising a plurality of transmissive units each of which converts a primary light distribution curve of the light from the light source into a corresponding different light distribution curve; and
moving the light transmissive element to make the light source be selectively positioned corresponding to one of the plurality of transmissive units of the light transmissive element.

20. The method of claim 19, wherein the plurality of transmissive units are selected from group of lenses consisting of planoconvex lens, convex lens, planoconcave lens, concave lens, spherical lens, and fresnel lens, each of the plurality of transmissive units comprises a light incident surface and a light emitting surface opposite to the light incident surface, and a microstructure is formed on at least one of the light incident surface and the light emitting surface.
